(19) United States
(12) Patent Application Publication
(10) Pub. No.: US 2008/0018669 A1
(43) Pub. Date: Jan. 24, 2008

(54) METHOD AND SYSTEM FOR INTEGRATED IMAGE ZOOM AND MONTAGE

(75) Inventor: David Thomas Gering, Waukesha, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/458,268

(22) Filed: Jul. 18, 2006

(51) Int. Cl. G09G 5/00

(52) U.S. Cl. 345/660

(57) ABSTRACT

The present application discloses a method of integrating image zoom and montage. The method comprises generating a montage using at least one neighboring image while zooming-out an image; and displaying the zoomed-out image with the montage. The neighboring images may be selected depending upon various features disclosed. The method further comprises panning the montage for selecting an image, placing the same at the center of the montage, and zooming-in the selected image. Also disclosed is a display system incorporating an integrated interface for image zoom and montage.

### FIELD OF THE INVENTION

This invention generally relates to the field of display methods and systems. More particularly, this invention relates to a display method and system for integrating zoom and montage.

### BACKGROUND OF THE INVENTION

In recent display systems, the display systems provide features of zooming-in and zooming-out of an image. The zooming-in feature in its general sense refers to expanding, enlarging or magnifying the image, and the zooming-out feature refers to compressing, contracting, or reducing the image. These features allow the user to study or analyze the image more clearly and conveniently. Normally a zoomed-out image is displayed with a blank background. The zooming-in and zooming-out features are normally achieved through a user interface connected to the display system. In some of the existing display systems zooming and panning are typically implemented with a convenient real-time mouse interface. For example, dragging while pressing the left mouse button pans, and dragging while pressing the right mouse button zooms.

Some of the advanced display systems introduce a feature of montage. A montage refers to a tiling, or 2-D array of images, constructed from a set of images acquired at various slice locations or time-points. A montage in a display system is generally provided to allow simultaneous viewing of multiple images.

However in current display systems, the features of zooming in and zooming out are not associated or integrated with the feature of montage. For example, during zooming-out of an image, the zoomed-out image is displayed with a blank background. Similarly, if a zoomed-in image is generated from a zoomed-out image, the zooming-in of the image is performed using only one tile, the zoomed-out image tile, rather than a different tile that might have aided the user's understanding of the dataset.

Some of the existing display systems use a blending of images as a part of image fusion. Generally this is referred to as overlay. In the existing systems, blending is performed in various ways. However these systems do not associate or integrate blending with montage, resulting in decreased image quality.

Thus it would be desirable to provide an interface between zoom and montage in a displaying system. It would also be desirable to provide a displaying system capable of displaying images with integrated zoom and montage.

### SUMMARY OF THE INVENTION

The above-mentioned shortcomings, disadvantages and problems are addressed herein which will be understood by reading and understanding the following specification.

The present invention provides a method of integrating image zoom and montage. The method comprises the steps of: (a) generating a montage using at least one neighboring image while zooming-out an image; and (b) displaying the zoomed-out image within the montage. In an embodiment, the neighboring images are configured to be images selected from nearby spatial locations of the zoomed-out image, nearby time points of the zoomed-out image in a dynamic acquisition, or acquisitions using different imaging protocols or different patients.

In another embodiment, a method of displaying an image using integrated zoom and montage is described. The method comprises the steps of: (a) generating a montage using at least one neighboring image while zooming-out an image; (b) panning the montage to select an image from the montage; (c) placing the selected image at the center of the montage; and (d) zooming-in the selected image. The method further comprises displaying a zoomed-out image with the montage as the background.

In yet another embodiment a system for displaying an image is disclosed. The system comprising: an imager for providing images of an object; a processor coupled to the imager comprising: i. means for generating a montage based on at least one neighboring image; ii. means for panning the montage to select an image and place the selected image at the center of the montage; and iii. means for zooming in the image using the selected image. The system also includes a display device coupled to the processor for displaying: i. a zoomed out image with the montage; and ii. a zoomed in image using a selected image from the montage.

Various other features, objects, and advantages of the invention will be made apparent to those skilled in the art from the accompanying drawings and detailed description thereof.

### BRIEF DESCRIPTION OF THE DRAWINGS

FIG. 1 is a high level flowchart depicting exemplary steps of providing an integrated interface for image zoom and montage;

FIG. 2 is a flowchart describing, in greater detail, the exemplary steps of providing an integrated interface for image zoom and montage illustrated in FIG. 1;

FIG. 3 illustrates a schematic diagram of a display system capable of providing an integrated interface for image zoom and montage as described in an embodiment of the invention;

FIG. 4A illustrates a zoomed-in image according to the prior art as well as embodiments of the invention;

FIG. 4B illustrates a zoomed-out image according to the prior art;

FIG. 4C illustrates a zoomed-out image in accordance with an embodiment of the invention; and

FIG. 5 illustrates an embodiment of the invention using image fusion.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments a method of providing an integrated interface for image zoom and montage comprising the steps of: (a) generating a montage using at least one neighboring image while zooming-out an image; and (b) displaying the zoomed-out image with the montage. The zooming-in in its general sense refers to expanding, enlarging or magnifying the image, and zooming-out refers to compressing, contracting, or reducing the image.

In another embodiment the invention provides zooming-in of an image from a zoomed-out image using a different tile. This would allow the user to rapidly transition between “bird's eye” views and “close-up” views, which could aid the user's understanding of the image data. Also in another embodiment, the invention provides fusing an image using a montage generated based on at least one neighboring image.

Thus various embodiments of integrating zoom with montage, and a display system providing the integrated montage and zoom, are disclosed. However, it should be noted that the invention is not limited to this or any particular application or environment. Rather, the technique may be employed in a range of applications, any display systems, such as a computer output surface or projecting mechanism that shows text and graphic images to a computer user, using a cathode ray tube (“CRT”), liquid crystal display (“LCD”), light-emitting diode, gas plasma, or other image projection technology, to mention a few. The invention also discloses a method and system for having real time interaction of zoom or pan interface.

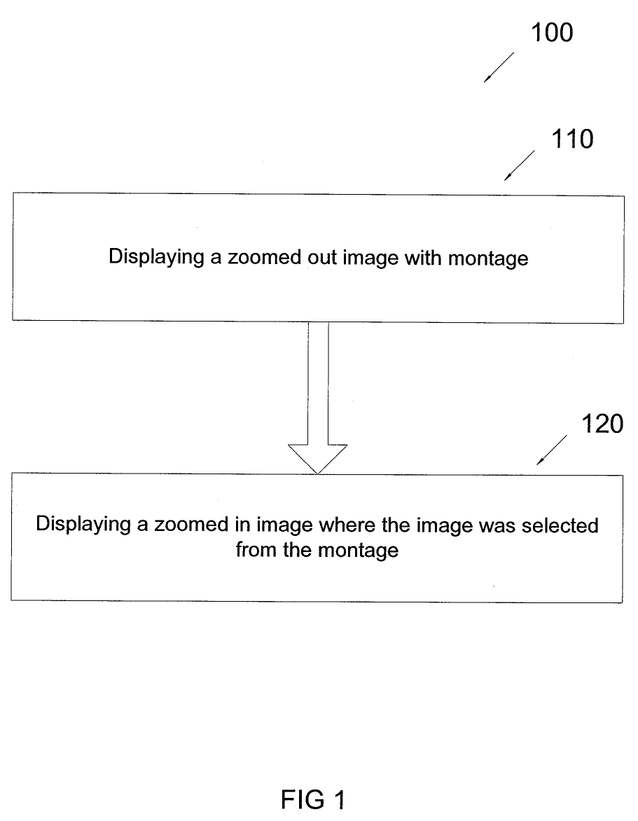

FIG. 1 is a high level flowchart, depicting exemplary steps of providing an integrated interface for image zoom and montage. An illustrated embodiment 100, provides a method of displaying zoomed-in and zoomed-out image. At block 110, a zoomed-out image is displayed with montage in the surrounding display area. The montage is a two dimensional array of images generated from a set of one or more images. In various embodiments of the invention, the montage is generated using at least one neighboring image.

In an embodiment, the neighboring images include images selected from nearby spatial locations of the zoomed-out image. While zooming-out an image, the montage is generated using the near-by images of the zoomed-out image.

In another embodiment, the neighboring images include images at nearby time points of the zoomed-out image, from a dynamic acquisition. In dynamically acquired images, the images having near-by time points or the images acquired simultaneously shall be used as neighboring images.

In yet another embodiment the neighboring images include images from similar locations of an object being imaged using different imaging protocols. If the invention uses different imaging systems for capturing the image, the neighboring images may be selected from different images obtained using different protocols and using different imaging systems. However the part being imaged will be the same. For example, the image of an “arm” of a patient is captured using different medical imaging devices. The different medical imaging device may include, X-ray imaging device, CT, MR, PET, etc, but not limited to these. Thus the slices captured for “arm” from different imaging devices may be used as neighboring images.

In yet another embodiment the neighboring images include images from different patients, but related according to some metric such as correlation.

Thus a montage is generated using neighboring images, the neighboring images being selected from nearby spatial locations of the zoomed out image, nearby time points of the zoomed out image from a dynamic acquisition, or different locations of an object being imaged using different imaging protocols or different patients. The montage is generated while the image is zoomed out. The zoomed-out image is displayed with the montage thus generated.

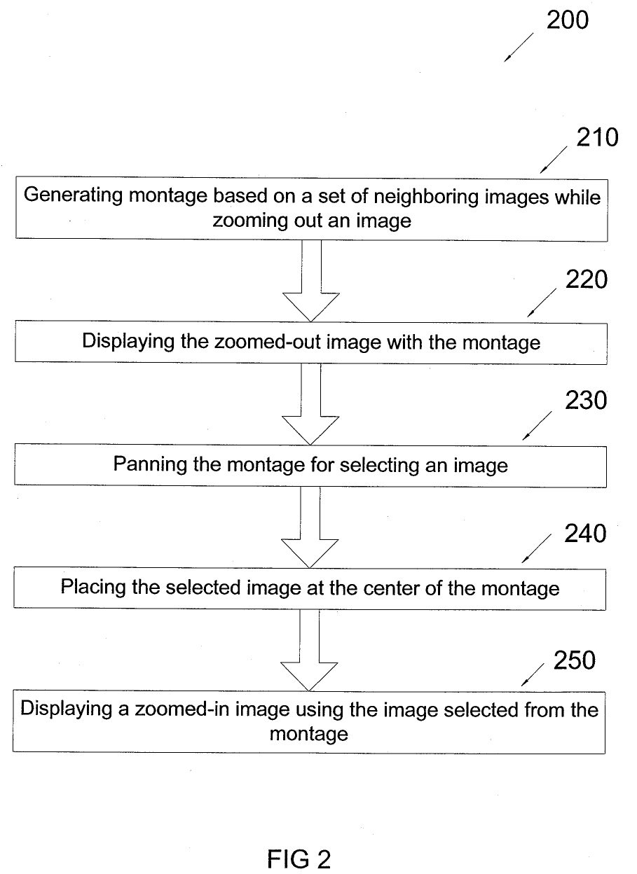

At block 120, a zoomed-in image is displayed using a selected image from the montage. The invention provides a unique way of zooming-in an image using a different tile than the zoomed-out tile. Exemplary steps involved in displaying the image are clearly illustrated in FIG. 2.

FIG. 2 is a flowchart describing, in greater detail, the exemplary steps of providing an integrated interface for image zoom and montage illustrated in FIG. 1. The method 200 illustrates a method of displaying a zoomed-in and zoomed-out image in accordance with an embodiment of the invention. At block 210, a montage is generated using at least one neighboring image. The montage is generated while the image is being zoomed-out. As a user interacts with the display system through a user interface to zoom an image, a zoom factor parameter is calculated. For example, a factor of 2.0 would result in magnifying the image by shrinking the field of view of the image by a factor of 2 in each dimension. A zoom factor of 0.5 would result in shrinking the image by expanding the field of view by a factor of 2 in each dimension. For zoom factors<1.0, a montage is computed in order to fill a display screen on which the image data is displayed with image data. With square images, for example, the montage contains an array of N×N image tiles, where N=1/(zoom factor), rounded up to the nearest odd integer. N can be restricted to be odd so that a selected image can be centered within the montage. Given N, the montage is computed by reformatting each image tile using standard methods for coordinate transformation and pixel interpolation known to those in the art.

At block 220, the zoomed-out image is displayed with the montage as the background. At block 230, the montage generated is panned. The term “pan,” “panning,” or the like means for a system user to traverse an image on a display in the horizontal and/or vertical direction (2-D roaming) using an interface device. Panning is performed to select an image from the montage. The image may be selected based on the choice of the user or any other predetermined specifications. At block 240, the selected image is placed at the center of the montage. At block 250, a zoomed-in image is displayed using the image selected from the montage.

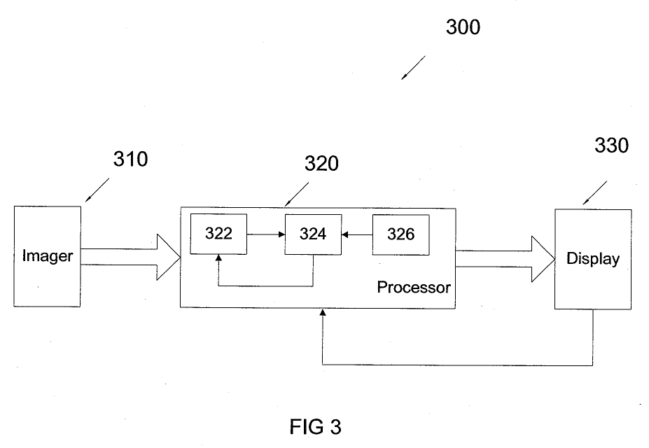

FIG. 3 illustrates a schematic diagram of a display system capable of providing an integrated interface for image zoom and montage as described in an embodiment of the invention. The display system 300 comprises an imager 310 for providing, continually in use, images of an object, a processor 320 for processing the image and generating the montage based on the instructions from the user or some predefined format and a display device 330 for displaying the images. The imager 310 includes any imaging device capable of capturing images. This may include digital cameras, medical imaging systems, industrial imaging systems, picture archive and communication system (PACS), etc. to mention a few. The processor 320 generates the montage image, while the image is being zoomed-out. The processor 320 comprises means for generating montage images 322, 324 and means for panning and zooming-in the image 326. In an embodiment the means for generating montage comprises a memory 322, and a display generator 324. An image database is stored in the memory 322. The image database comprises details of the image. The image database stores image data records containing graphical data correlated to stored images, preferably including image format data.

The image database is stored in the memory 322. It should be understood that any type of computer accessible memory or storage device capable of storing the desired amount of data and/or code may be used. Moreover, the memory or storage device may comprise one or more memory devices, such as magnetic or optical devices, of similar or different memory types, which may be capable to store the montage generated by the display generator. The memory also may be stored with software necessary for the operation of the display system.

The means for generating montage further comprises a display generator 324. The display generator 324 is electronically coupled to the image database in order to retrieve the image data stored in the image data records. The display generator 324 performs selecting the images from the image data based on the user instructions and performs arranging the images into a montage.

The processor 320 further comprises means for panning and zooming-in the image 326. The means for panning and zooming-in the image 326 comprises a user interface for interacting with the display system 300. The user interface may comprise a standard computer keyboard or mouse. The interface utilizes user-friendly point-and-click interface software, which may be stored in the memory. The interface will preferably permit the user to select and view any of the images stored in the image database. The user will typically be permitted to control the selection and arrangement process that the display generator performs during operation of the display system 300.

The display device 330 is coupled with the processor 320 for displaying the processed image or the montage generated. The display device may be any device capable of displaying images, including a computer output surface or projecting mechanism that shows text and graphic images to a computer user, using a cathode ray tube (“CRT”), liquid crystal display (“LCD”), light-emitting diode, gas plasma, or other image projection technology, to mention a few. While zooming-out the image, the processor generates the montage using at least one neighboring image and the display device 330 displays the zoomed-out image with the montage generated. As the user zooms-out more, each image tile shrinks smaller so that more tiles fit in the montage.

The montage generated may be panned by the user or automatically to select an image. The image may be selected by the user or by the system by default. The selected image is placed at the center of the montage. Subsequent zooming-in enlarges the tiles around this new center. Thus the display system displays the zoomed-in image using the image selected from the montage. Zooming-in can be performed to the extent of vanishing the montage from view, and this allows the user to examine a different image slice than the one being viewed prior to zooming out.

In an embodiment of the invention, the processor may fuse the image with the montage generated. This is performed by using the montage stored in the memory 322. The montage may be fused or blended with the image at the display generator 324 and the display generator 324 may feed the blended image to the display device 330 for display. The blending is performed based on the opacity values selected by the user. A parameter called alpha specifies the opacity of a foreground image that is overlaid on a background image.

In another embodiment of the invention, the zoomed-out images are reformatted from a scale-space version of the image rather than the original. Scale space is computed through a process of pyramiding that consists of the two (2) steps of smoothing the image with a Gaussian kernel followed by down sampling. Smoothing the image with the Gaussian kernel is used to prevent spurious artifacts. This act is performed at the processor 320.

In an embodiment of the invention, the user has the option of conveniently resetting the zoom/pan, so that single image fills the view.

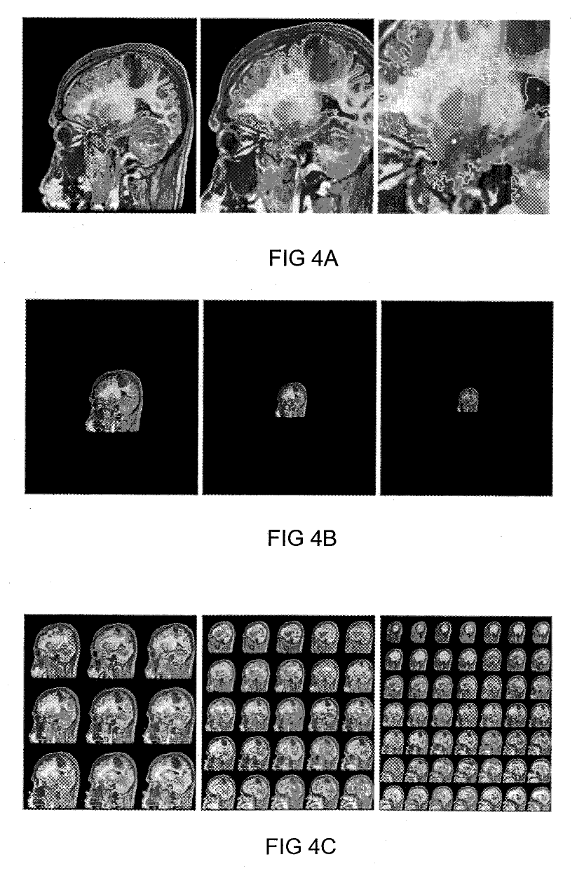

FIG. 4A illustrates a zoomed-in image according to the prior art as well as the invention. The FIG. 4A shows the effect of zooming-in of an image using the present invention as well as the prior art. The visibility of the zoomed-in image is same in the present invention as well the prior arts. However in the present invention the image may be zoomed-in using a different tile, selected from a montage. The invention also provides the flexibility of zooming-in an image using a tile other than the zoomed-out tile, if we are zooming-in the image form the zoomed-out image.

FIG. 4B illustrates a zoomed-out image according to the prior art. As seen, the zoomed-out image is displayed with a blank surrounding.

FIG. 4C illustrates a zoomed-out image in accordance with an embodiment of the invention. As described in an embodiment of the invention, the zoomed-out image is displayed with the montage. A comparison between FIGS. 4B and 4C shows this embodiment provides the user with additional information that can assist the user in interpreting the image, thereby possibly leading to better diagnosis or therapy.

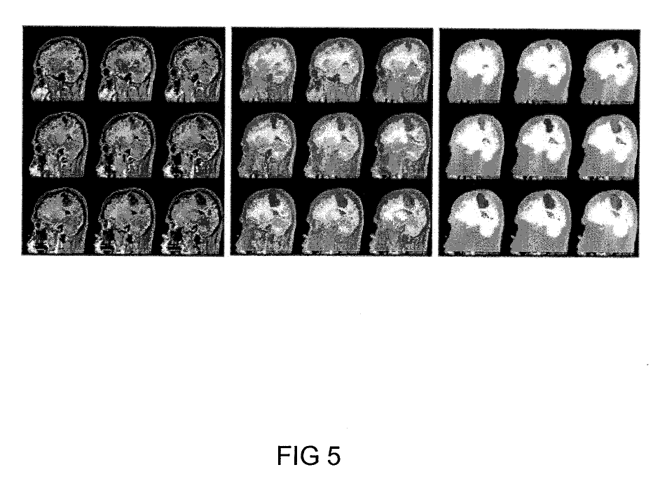

FIG. 5 illustrates an embodiment of the invention using image fusion. Image fusion is a process, which produces a single image from a set of input images. It is performed for the purpose of viewing multiple forms of image data simultaneously. Image blending is a technique used for achieving image fusion. In an embodiment of the invention, the fused images are each montages. A foreground montage is overlaid with a specified opacity on a background montage. The opacity value is an arbitrary parameter, adjustable by the user, and referred to as alpha. FIG. 5 shows a set of images blended with values of alpha 0, 50, 100.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. A method of integrating image zoom and montage comprising the steps of:
(a) generating a montage using at least one neighboring image while zooming-out an image; and
(b) displaying the zoomed-out image with the montage.

2. The method of claim 1, further comprising panning the montage for selecting an image.

3. The method of claim 2, further comprising placing the selected image at the center of the montage.

4. The method of claim 3, further comprising displaying a zoomed-in image using the selected image.

5. The method of claim 1, wherein the montage is a two-dimensional array of images generated from a set of one or more images.

6. The method of claim 1, wherein the at least one neighboring image includes at least one image from a nearby spatial location of the zoomed-out image.

7. The method of claim 1, wherein the at least one neighboring image includes at least one image at a nearby time point of the zoomed out image in a dynamic acquisition.

8. The method of claim 1, wherein the at least one neighboring image includes at least one image from a similar location of an object imaged using a different imaging protocol.

9. The method of claim 1, wherein the at least one neighboring image includes at least one image from a different patient.

10. The method of claim 1, further comprising blending the zoomed-out image with the montage based on an opacity value selected by a user.

11. The method of claim 1, further comprising reformatting the zoomed-out image based on a scale space version of the montage.

12. A method of displaying an image comprising the steps of:
(a) generating a montage using at least one neighboring image while zooming-out an image;
(b) panning the montage for selecting an image from the montage;
(c) placing the selected image at the center of the montage; and
(d) zooming-in the selected image.

13. The method of claim 12, further comprising displaying the zoomed-out image with the montage.

14. The method of claim 12, wherein the step of zooming-in comprises
displaying the zoomed-in image using the selected image.

15. The method of claim 12, wherein the at least one neighboring image is configured to be at least one image selected from a nearby location of the zoomed-out image, a nearby time point of the zoomed-out image in a dynamic acquisition, or an image acquired using a different imaging protocol or different patient.

16. The method of claim 12, further comprising blending the image with the montage based on an opacity value selected by a user.

17. A system for displaying an image comprising:
an imager for providing images of an object;
a processor coupled to the imager comprising:
i. means for generating a montage based on at least one neighboring image while zooming out an image;
ii. means for panning the montage for selecting an image and placing the selected image at the center of the montage; and
iii. means for zooming in the image using the selected image and a display device coupled to the processor for displaying:
i. a zoomed out image with the montage
ii. a zoomed in image using a selected image from the montage

18. The system of claim 17, wherein the means for generating a montage comprises a memory and a display generator.

19. The system of claim 17, wherein the memory is configured to store an image data base and the montage.

20. The system of claim 18, wherein the means for generating a montage is further configured to select at least one neighboring image, the neighboring image being selected from a group comprising an image selected from a nearby location of the zoomed out image, a nearby time point of the zoomed out image in dynamic acquisition, and an image acquired using a different imaging protocol or different patient.

21. The system of claim 16, wherein the means of panning and zooming-in comprises a user interface capable of interacting with the system.

22. The system of claim 16, wherein the processor and the display device is coupled to provide an integrated interface for image zoom and the montage.
